(19) United States
(12) Patent Application Publication
(10) Pub. No.: US 2025/0052299 A1
(43) Pub. Date: Feb. 13, 2025

(54) CONNECTING MEANS, REINFORCING DEVICE, CONNECTING ASSEMBLY AND METHOD OF ARRANGING COMPONENTS

(71) Applicant: B.T. Innovation GmbH, Magdeburg (DE)

(72) Inventor: Felix VON LIMBURG, Magdeburg (DE)

(21) Appl. No.: 18/722,248

(22) PCT Filed: Dec. 21, 2022
(86) PCT No.: PCT/EP2022/087267

§ 371 Date: Jun. 20, 2024

(30) Foreign Application Priority Data
Dec. 21, 2021 (DE) 10 2021 134 159.0

(51) Int. Cl. F16G 15/04

(52) U.S. Cl. CPC F16G 15/04

(57) ABSTRACT

A connecting means for connecting mutually spaced components, said connecting means comprising: at least two connecting devices by means of which the connecting means can be attached to one of the at least two components, respectively; and a coupling device which couples the at least two connecting devices to one another at least in order to transmit tensile forces. In order to improve the connection and handling of the components, at least one of the connecting devices is coupled to a coupling section of the coupling device so as to be fixed at least with respect to the axial direction.

The present invention relates to a connecting means, a reinforcing device, a connecting assembly and a method of arranging components.

From DE 83 32 560 U1, a connecting means according to the preamble of claim 1 is known. Therein, in particular, a turnbuckle is disclosed as a connecting means which has two tensioning devices as connecting devices which can be connected to components. Furthermore, the tensioning devices are each coupled to a coupling device which comprises tensioning sleeves connected in the manner of a chain link. The tensioning devices each comprise a threaded device which is screwed into a tensioning sleeve for tensioning.

However, enough space must be provided in the tensioning sleeves to allow the respective threaded devices to be screwed into the tensioning sleeve, thus in the direction of the coupling device. The space required makes the connecting means bulky. Furthermore, if the threaded device is screwed in deeply, it is difficult to actuate the connecting means at the coupling device.

Therefore, the underlying problem of the present invention is to provide a compact and easy-to-handle connecting means and to improve the connection and handling of the components.

This problem is solved by a connecting means according to claim 1.

According to a first aspect, a connecting means is provided for connecting at least two components, in particular precast concrete parts, spaced apart along an axial direction of the connecting means, wherein the connecting means comprises: at least two connecting devices via which the connecting means can be attached to one of the at least two components, respectively, and a coupling device which couples the at least two connecting devices to one another at least in order to transmit tensile forces.

Differing from DE 83 32 560 U1, at least one of the connecting devices is coupled to a coupling section of the coupling device so as to be fixed at least with respect to the axial direction.

While the threaded device in the prior art is movable along the axial direction of the connecting device with a rotation and therefore the above-mentioned space must be provided, the at least one connecting device according to the first aspect does not move along the axial direction of the connecting device. Therefore, no space needs to be provided for axial displacement of the at least one connecting device. Thus, the connecting means as such can be kept compact. Furthermore, an actuating device can easily be applied to and/or in the coupling device in order to actuate the connecting means. In particular, the at least one connecting device is axially fixed to the coupling section even during actuation.

Preferably, the at least two connecting devices are each coupled to a coupling section of the coupling device so as to be fixed at least with respect to the axial direction.

This means that each of the connecting devices can be coupled to the coupling device in a space-saving manner. This further improves the compactness and handling of the connecting means.

Preferably, the at least one connecting device is movably coupled to the respective coupling section at least for attachment to the respective component, furthermore preferably coupled to the respective coupling section so as to be rotatable about the axial direction, in particular by at least 90°, again preferably freely.

This can facilitate attachment to the respective component. For example, a threaded device of the connecting device can be attached to the component by rotating it around the axial direction. Tolerances can also be compensated for more easily. In this context, the respective coupling section can, for example, also have an elongated hole, preferably transverse to the axial direction.

According to a further aspect, the at least one connecting device can comprise a fastening means, in particular a threaded device, which is preferably screwable to the respective component.

Preferably, the connecting device is formed by the fastening means. By means of the fastening means, the connecting means can be attached directly to the respective component. A fastening means is characterized in particular by the fact that it can be attached directly to the component by form fit and/or force fit. In other words, it does not require any additional means of attachment. Examples of fastening means are threads, rivets, bayonet elements and so on. The threaded device allows the connecting means to be tensioned in a simple manner. Preferably, a threaded section of the threaded device is screwed directly into the respective component. Thus, the configuration can still be kept compact, whereas in the prior art further elements are provided on a side of the threaded device close to the component for attachment to the component.

Preferably, the at least two connecting devices have a threaded device of the same type of pitch, preferably a right-hand thread.

Alternatively, at least one connecting device can have a threaded device with a right-hand thread and at least one other connecting device can have a threaded device with a left-hand thread.

In the case of an identical type of thread pitch, the configuration of the components is simple, wherein the respective connecting device can be actuated individually. In the other case, the connecting means can be tensioned and/or attached to the respective component in a synchronous manner. In particular, tensioning and/or attachment to both components can be performed by rotating the coupling device.

According to still another aspect, the respective coupling section can have an opening section which preferably extends along the axial direction and through which at least a part of the at least one connecting device, preferably a shaft section of the threaded device, passes.

This allows simple support of the connecting device on the coupling section, wherein compactness in the axial direction and transversely thereto can be ensured. At the same time, the connecting device can be mounted in the opening section in such a way that the degree of freedom of movement is maintained.

Preferably, the connecting means has a first lock section, in particular a screw head of the respective threaded device, on a first side facing away from the respective component with respect to the opening section, which at least prevents the displacement of the at least one connecting device towards the respective component, and/or a second lock section on a second side facing the respective component with respect to the opening section, which at least prevents the displacement of the at least one connecting device away from the respective component.

This means that the connecting device can be axially fixed to the coupling section in a simple manner using the lock sections. If a screw head is used as one of the lock sections, the assembly effort and number of components can be reduced.

Preferably, the first and/or second lock section is formed by a shoulder section for actuating the connecting device.

This allows the connecting device to be actuated at the shoulder section and at the same time ensures axial fixing. Thus, the size of the connecting means can be kept small and additional components can be avoided. In particular, the lock section on the side close to the component can be formed by the shoulder section. This facilitates actuation.

According to yet another aspect, the coupling device can be configured such that the at least two connecting devices are movable relative to one another, preferably the respective coupling sections are movable relative to one another, in particular the coupling device can be configured to be soft under pressure and/or soft under bending and/or soft under torsion, at least in sections.

This allows tolerances and differences in alignment of the respective components and the respective connecting devices to be compensated for. Likewise, the respective components can even be moved relative to one another in a state in which the connecting means is attached via the respective connecting devices.

Preferably, the positions of the at least two connecting devices, in particular preferably of the respective coupling sections, can be moved relative to one another, in particular along the axial direction, and/or the alignment of the two connecting devices, preferably of the respective coupling sections, are changeable relative to one another.

As a result, the components can be moved towards each other and/or deviations of component attachment sections, to which the connecting devices are to be attached, respectively, can be compensated for in relation to each other.

According to yet another aspect, the coupling device can have at least one chain link, preferably a plurality of chain links, which are coupled in particular preferably in an undercutting and/or articulated manner, again preferably at least one chain link has the respective coupling section, wherein the coupling device further preferably comprises at least one reversibly accessible chain link, into which at least one further chain link can be coupled, in particular preferably has a carabiner link.

By means of the chain link, the coupling device can be configured compactly, wherein in particular a coupling section for the respective connecting device can be provided on both sides in an extension direction of the chain link. The chain link can also be easily actuated, for example the chain link can be rotated to attach the connecting devices. If a plurality of chain links arranged as specified above is provided, the coupling device can be flexibly configured. With at least one reversibly accessible chain link, further chain links can easily be added to adapt to different component spacing.

According to yet another aspect, the connecting means can be tensioned by screwing the at least one connecting device to the respective component.

In this way, the components can be tensioned in a simple manner and a tensile load can be applied to the coupling device.

Alternatively or additionally, the at least two connecting devices, in particular the respective coupling sections, can be spaced apart by screwing the at least one connecting device.

While in the prior art the screwing of the threaded devices to the coupling device moves the connecting devices towards each other, according to this aspect the coupling device can be configured compactly, since no space has to be provided to accommodate the connecting devices.

Additionally or alternatively, the connecting means can be tensioned by spacing the connecting devices apart.

This is another simple way of tensioning the components and applying a tensile load to the coupling device.

According to yet another aspect, the coupling device can have a force measuring device that can measure a force acting on the coupling device, preferably a tensile force.

This makes it easy to determine the tensile force acting on the connecting means. It also allows the tensioning of the components to be set precisely. In particular, the force measuring device can have a display section on which the acting force can be read.

According to yet another aspect, the connecting means can be made at least in sections, preferably entirely of metal, again preferably of steel, in particular tensile-resistant steel.

This allows the acting forces to be transmitted safely between the components. In particular, the coupling device can be made at least in sections from the aforementioned materials.

Another aspect of the present invention relates to a reinforcing device for load transmission between two components, comprising: a base portion which is attachable to one of the components by means of a connecting device of the connecting means according to at least one of the preceding aspects with an attachment section, and a reinforcing section which is coupled to the base portion and via which a load can be transmitted between the components.

The force transmission between the two components can be improved by such a reinforcing device. In particular, a stable connection can be created via the reinforcing device. The reinforcing device can furthermore be attached to the one component in a simple manner via the connecting means of the preceding aspects, in particular via the connecting device thereof.

Preferably, the attachment section has an opening section through which the one connecting device can extend.

The reinforcing device can thus be attached to the one component in a simple and space-saving manner and coupled to it by the connecting device extending at least in sections through the opening section, in particular if the connecting device has a threaded device that is screwed into the one component through the opening section. In this context, the reinforcing device, or more precisely the base portion, can be pressed against the one component. The opening section can, for example, comprise or be a through-hole. In particular, the opening section may comprise or be at least one elongated hole, preferably at least two intersecting oblong holes.

Alternatively or additionally, the reinforcing section can be adjustably coupled to the base portion.

Thus, the reinforcing section can be set on site according to the geometries and the arrangement of the components in at least one of position and orientation. For this purpose, the reinforcing device may comprise adjustment means, for example comprising at least one elongated hole in the base portion and/or the reinforcing section.

In particular, the reinforcing section can be adjustably coupled to the base portion in at least one direction perpendicular to the axial direction and/or in the axial direction of the connecting device that couples the reinforcing device to the one component.

This can further increase flexibility.

In the reinforcing device, the reinforcing section may further comprise a compressive load section, which is substantially subjected to compression when the load is transmitted, and/or a tensile load section, which is substantially subjected to tension when the load is transmitted.

This means that the reinforcing device can withstand various loads.

Furthermore, the reinforcing section can comprise at least one straight extension section, in particular a rod section, which can transmit a force in its extension direction.

This allows a well-defined force transmission to be achieved.

At least one straight extension section is preferably arranged essentially parallel to the axial direction and/or at least one straight extension section is arranged essentially parallel to the direction of gravity.

In this way, a load caused by gravitational forces that occurs when the components are axially spaced apart can be responded to.

Furthermore, a straight extension section preferably extends in the direction of gravity and to the side of the base portion at an end section of the straight extension section arranged parallel to the axial direction, the end section facing away from the base portion.

This allows a load caused by gravitational forces to be supported by the reinforcing device. In particular, compressive forces and tensile forces can be transmitted.

Furthermore, the reinforcing section can be formed in a closed shape, in particular essentially in a triangular shape, preferably in the shape of a right-angled, in particular isosceles, triangle.

Thus, a stable force transmission similar to a framework can be achieved. In this context, the triangular shape can be formed by three straight extension sections connected to each other.

Furthermore, it is preferred that the attachment section is spaced apart from a reinforcing section coupling section, at which the reinforcing section is coupled to the base portion, in a direction perpendicular to the axial direction of the connecting device.

Thus, the attachment of the reinforcing device to the one component can be carried out without being restricted by the reinforcing section.

A further aspect of the present invention is directed to a connecting assembly comprising: at least two components, preferably precast concrete components; and the connecting means according to at least one of the preceding aspects, wherein one connecting device is attached to one of the at least two components, preferably screwed thereto, and the other connecting device is attached to the other of the at least two components, preferably screwed thereto.

This means that the components can be coupled to one another by the connecting means for the transmission of loads. In particular, the components can be preloaded.

Preferably, the at least two components are freely movably supported on one another, except for the connecting means.

The connecting means thus serves as a securing means. The connecting means can thus prevent the components from being separated from each other without being connected.

The connecting assembly may further comprise the reinforcing device according to one of the above aspects, wherein the base portion is attached to the one component by means of the one connecting device and the reinforcing section is arranged at least in sections, preferably entirely, in a, preferably axial, space between the components, and in particular preferably the space is filled with a structure bonding agent, preferably comprising concrete and/or mortar.

The connecting means can thus be used to provide the reinforcing device in the space, for example an interstice, and stabilize the connection between the components. If the space is filled with a structure bonding agent, the load can be at least partially introduced into the reinforcing device, in particular by the hardened concrete and/or mortar, which thus reinforces the structure bonding agent.

Preferably, the space has at least one undercut in the axial direction with at least one of the components.

Thus, a tensile load can be introduced into the space by the components, which can be transmitted via the reinforcing device.

In the connecting assembly, the reinforcing device is preferably arranged with at least one of the features specified above. For example, at least one of the straight extension sections of the reinforcing device may be aligned in the axial direction.

Alternatively or additionally, one of the straight extension sections of the reinforcing device can be aligned at an angle, preferably between 30° and 60°, in particular 45°, to the axial direction.

This simplifies the load transmission.

In order to create the above connecting assembly, a method may be provided comprising the steps of:
arranging the components relative to each other;
attaching the connecting means to the components via the respective connecting devices, preferably coupling the reinforcing device to one of the components in accordance with the above;
preferably tensioning the components via the connecting means; and
further preferably filling a, in particular axial, space between the components with a structure bonding agent, preferably comprising concrete and/or mortar, wherein in particular preferably the reinforcing section of the reinforcing device is arranged in the space.

In particular, the steps are to be carried out in this order, wherein the structure bonding agent can be cured at the end.

Furthermore, a method for arranging at least two components is provided, wherein the at least two components are connected by the connecting means according to at least one of the preceding aspects, wherein the components are moved, preferably relative to one another, by an actuation on the coupling device, and preferably, after the arranging has taken place, at least one of the connecting devices is adjusted with respect to the respective component, in particular by screwing it to the respective component.

By means of the connecting means according to the invention, the components can be moved in space by actuating the coupling device, thus applying a load to the coupling device. If the coupling device has a flexible configuration, the components can also be moved relative to each other. If, for example, the components are moved towards each other, they can be tensioned again by the connecting device after they have been arranged, that is, in the final arranging state.

The above aspects are explained in detail below with reference to the attached drawings.

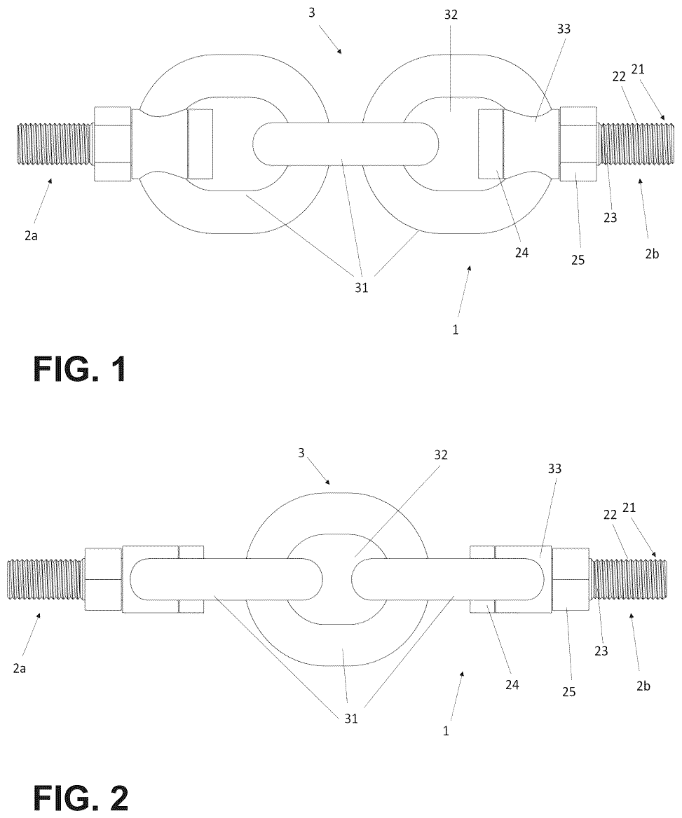

FIG. 1 shows a connecting means according to a first embodiment in top view.

FIG. 2 shows a side view of the connecting means according to the first embodiment.

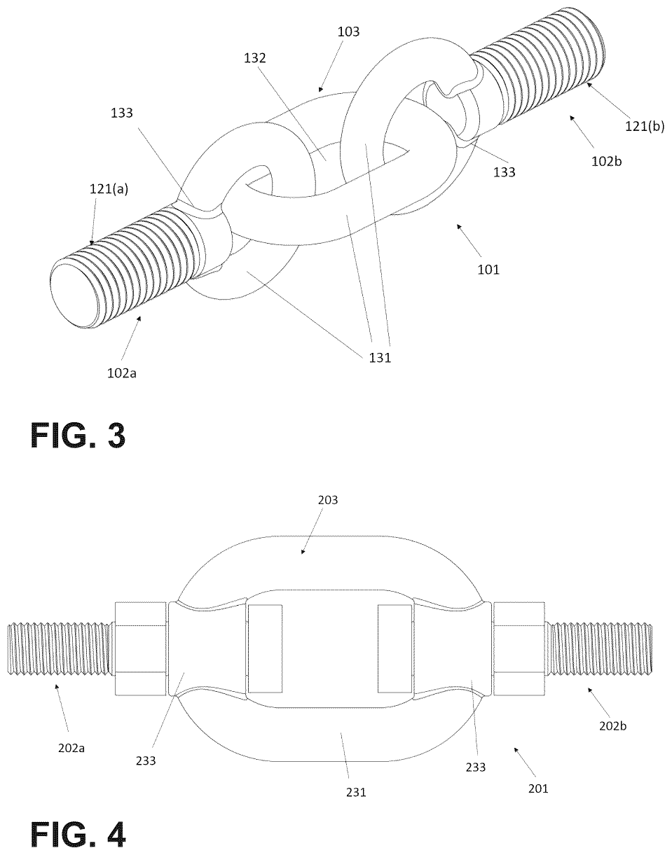

FIG. 3 shows a perspective view of a connecting means according to a second embodiment.

FIG. 4 shows a connecting means according to a third embodiment in top view.

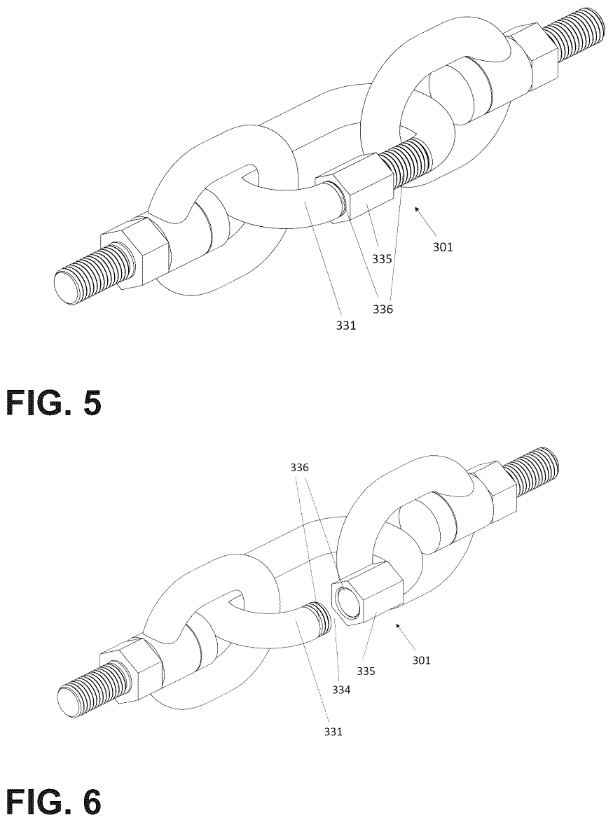

FIG. 5 shows a connecting means according to a fourth embodiment in isometric view in a closed state of an inner chain link.

FIG. 6 shows the connecting means with the inner chain link in an open state.

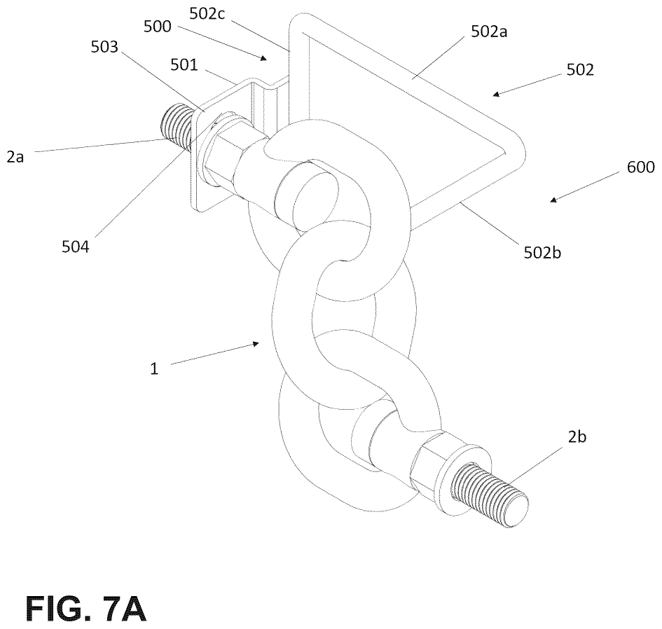

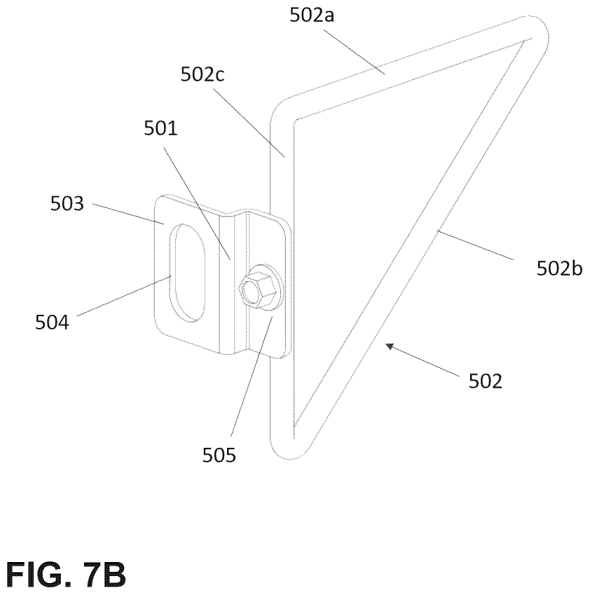

FIG. 7A shows a reinforcing device according to the invention in perspective view with connecting means in a connecting assembly according to the invention. FIG. 7B shows another perspective view without the connecting means.

FIG. 1 shows a connecting means 1 in top view. FIG. 2 shows a side view of the connecting means 1. The connecting means 1 has a first connecting device 2a and a second connecting device 2b, which are opposite each other. The connecting devices 2a and 2b are coupled to one another via a coupling device 3.

The connecting devices 2a and 2b and the coupling device 3 extend in an extension direction from left to right in FIG. 1, which corresponds to an axial direction of the connecting means.

FIGS. 1 and 2 show the connecting means 1 in a state in which the entire connecting means 1 extends in the axial direction. Specifically, the axial direction of the first connecting device 2a, the axial direction of the second connecting device 2b and the axial direction of the coupling device 3 are aligned with each other. In this state, the connecting means 1 can be used to connect axially spaced components (not shown). Furthermore, the attachment sections of the components are aligned with each other in this state.

The connecting devices 2a and 2b are identically constructed.

Each connecting device has a threaded device 21, for example a screw. The threaded device 21 has a threaded section 22, which is provided on a shaft section 23 of the threaded device 21. The shaft section 23 defines the axial direction of the respective connecting device 2a and 2b by its extension direction. The threaded section 22 is configured here in the form of an external thread, which can be screwed into an internal thread provided in the component, for example. However, an internal thread can also be provided. The threaded devices 21, in particular the threaded section thereof, have threads of the same type of pitch and preferably the same lead. The threads of the same type of pitch can be right-hand or left-hand threads.

The connecting device further comprises a screw head 24 provided at an end of the shaft section 23 away from the component. The screw head 24 is a first lock section within the meaning of the claims.

The connecting device further comprises a hexagon nut 25. The hexagon nut 25 is fixed to the shaft section 23. The hexagon nut 25 serves as a second lock section within the meaning of the claims. The hexagon nut 25 further functions as a shoulder section on which a tool for actuating the connecting device 2a, 2b is mounted. Thus, the shoulder section also forms the second lock section.

The coupling device 3 comprises a plurality, namely three in the embodiment, of chain links 31, which are connected directly in series. The chain links 31 are each coupled to the adjacent chain link 31 in an undercutting and articulated manner, so that they can perform relative movements to each other, but are secured to each other by a form fit. In FIGS. 1 and 2, the extension direction of each chain link 31 coincides with the axial direction of the connecting means 1. Furthermore, the chain links 31 are alternately rotated by essentially 90° around the axial direction.

Each chain link has a closed, essentially elliptical shape that surrounds a cavity 32. The chain links 31 extend essentially between the connecting devices 2a and 2b. The screw heads 24 as lock sections are each arranged inside the coupling device 3, in particular accommodated in the respective cavity 32.

The two outermost chain links 31 each have a coupling section 33. The coupling section 33 is provided at one end in the extension direction, which runs along the large main axis of the elliptical shape, of the respective chain link 31, that is, on a side of the respective chain link 31 close to the component in the state shown in FIGS. 1 and 2. The coupling sections 31 are thus provided at opposite end sections of the coupling device 3.

The coupling section 33 includes an opening section extending in the extension direction of the chain link 31. Thus, the coupling section 33 may be formed by an eyelet member welded to a main section of the chain link 31 having a recess at an end section in the direction of the major main axis for receiving the eyelet member.

The shaft section 23 of the connecting device extends through the opening section. As can be seen in particular in FIG. 1, the screw head 24 is located on a side of the opening section away from the component and the hexagon nut 25 is located on a side of the opening section close to the component. Both the screw head 24 and the hexagon nut 25 each have a larger external cross-sectional dimension, in particular a larger diameter, than at least one region of the opening section, so that a relative movement of the connecting device to the chain link 31 can be prevented by the screw head 24 and the hexagon nut abutting against the coupling section 33. In the opening section, the connecting devices 2a and 2b are each movably mounted, in particular rotatable about the axial direction. Axial fixing is preferably achieved by a form fit, but can also be achieved by a force fit or material connection.

Functions and effects of the present inventions are described below.

By means of the connecting means 1, at least two components spaced apart along the axial direction of the connecting means, in particular precast concrete parts, can be connected. The connecting means 1 comprises: at least two connecting devices 2a and 2b, via which the connecting means 1 can each be attached to one of the at least two components, and a coupling device 3, which couples the at least two connecting devices to one another at least for the transmission of tensile forces. A state in which tensile forces can be transmitted is shown in FIGS. 1 and 2. By means of a form fit, the individual chain links 31 are brought into contact with each other so that tensile forces can be transmitted at the contact sections.

As described above, each of the connecting devices 2a and 2b is coupled to the coupling section 33 of the coupling device 3 so as to be fixed at least with respect to the axial direction. Both when the connecting means 1 is subjected to compressive and tensile load, the connecting device is fixed axially, thus in both directions. The connecting devices are also axially fixed when the connecting device is actuated (attached or detached).

This allows the tensile force to be reliably introduced into the coupling device. In addition, no space needs to be provided for axial displacement of the connecting devices 2. Thus, the connecting means 1 can be kept compact as such. Furthermore, an actuating device, such as a hydraulic mechanism or a robot, can easily be attached to and/or in the coupling device 3 in order to actuate the connecting means 1. In particular, the actuating device can engage in the chain links 31, that is, in the respective cavity 32, of the respective outer chain links 31 in order to attach the connecting devices 2a and 2b to the respective components or to move the respective components relatively by moving the outer chain links 31 to one another when connecting devices are already attached.

Furthermore, each of the screws and thus the connecting devices 2a and 2b is coupled to the respective coupling section 33 of the coupling device 3 so as to be fixed at least with respect to the axial direction.

Thus, each of the connecting devices 2a and 2b can be coupled to the coupling device 3 in a space-saving manner. The compactness and handling of the connecting means 1 can thus be further improved.

In each case, the screw is movably coupled to the respective coupling section 33. The screw can rotate freely back and forth in the opening section 33. In particular, the connecting device is here a device that moves integrally as a unit.

This can facilitate the attachment to the respective component. By rotating about the axial direction, the screw can be attached to the component while being axially immovable with respect to the coupling device. Tolerances can also be compensated for more easily. Instead of or in addition to the rotational degree of freedom, an elongated hole can also be provided in the coupling section. This enables movement transverse to the axial direction of the connecting device.

The connecting device 2a and 2b can each be attached directly to the respective component. In particular, the screw can be screwed directly to the respective component as a threaded device. The threaded section 22 is provided in particular on a side close to the component, thus an outside, with respect to the coupling section. As a result, the coupling device 3 is pulled in the direction of the component during screwing.

In this way, the connecting means can be tensioned in a simple manner and the configuration can be kept compact.

The coupling section 33 has an opening section which extends along the axial direction and through which at least a part of the respective connecting device 2a and 2b, in particular the shaft section 23 of the threaded device 21, extends.

This allows simple support of the connecting device 2a and 2b on the respective coupling section 33. At least one bearing, preferably a rolling bearing, can be provided between the connecting device and the opening section.

The connecting means 1 has a first lock section 24, the screw head 24 of the respective threaded device 21, on the side away from the component, which prevents at least the displacement of the connecting device towards the respective component, and has the second lock section 25, the hexagon nut, on the side close to the component, which prevents at least the displacement of the at least one connecting device away from the respective component.

Thus, the connecting device 2a and 2b can be axially fixed to the coupling section 33 in a simple manner by the lock sections. If the screw head 24 is used as one of the lock sections, the assembly effort and number of components can be reduced.

The coupling device 3 is configured such that the at least two connecting devices 2a and 2b are movable relative to each other. In particular, the respective coupling sections 33 are movable relative to each other. Due to the plurality of chain links 31, which in FIGS. 1 and 2 can transmit tensile forces, but can be moved relative to one another under compressive, bending and torsional loads, the coupling device 3 is configured to be soft in compression and soft in bending and torsion, at least in sections. It should be noted at this point that the coupling device can also comprise a rope that has similar properties.

As a result, tolerances, misalignment and differences in alignment of the respective components and the respective connecting devices 2a and 2b can be compensated for. It should be noted that FIGS. 1 and 2 show a state of flush alignment. Likewise, the respective components can even be moved relative to each other in a state in which the connecting means 1 is attached via the respective connecting devices 2a and 2b.

The positions of the at least two connecting devices 2a and 2b, in particular the respective coupling sections 33, relative to one another are movable along the axial direction. In addition, the alignments of the two connecting devices 2a and 2b, thus their extension directions and those of the coupling sections 33, are changeable relative to one another.

As a result, the components can be moved towards each other and/or deviations of component attachment sections, to which the connecting devices are to be attached, respectively, can be compensated for in relation to each other.

The coupling device 3 has a plurality of chain links 3, which are coupled in an undercutting and/or articulated manner. Furthermore, the two outer chain links 33 have the respective coupling section 33.

By means of the chain links 31, the coupling device 3 can be made compact. The chain link can also be easily actuated. If a plurality of chain links arranged as specified above is provided, the coupling device 3 can be configured flexibly.

The number of three chain links is preferred in this case because compactness is maintained and differences in alignment and misalignment of the connecting devices 2a and 2b can be compensated for.

The connecting means 1 can be tensioned by screwing the connecting devices 2a and 2b to the respective component. In this way, the components can be easily tensioned and a tensile load can be applied to the coupling device 3.

By screwing the connecting devices 2a and 2b, the at least two connecting devices 2a and 2b, in particular the respective coupling sections 33, can be spaced apart from one another. Thus, no space needs to be provided to accommodate the connecting devices.

The connecting means can also be tensioned by spacing the connecting devices 2a and 2b apart. This allows the chain links 31 to be brought reliably into contact with one another and the components can be tensioned in a simple manner and a tensile load can be applied to the coupling device 3.

The connecting means 1 is made at least in sections, preferably completely, of metal, again preferably of steel, in particular tensile-resistant steel. This allows the acting forces to be transmitted safely between the components. In particular, the chain links 31 of the coupling device 3 can be made at least in sections from the materials mentioned.

A further embodiment is shown in FIG. 3.

FIG. 3 shows an isometric view of a connecting means 101. The structure of the connecting means 101 essentially corresponds to that of the connecting means 1.

However, in the second embodiment, the respective threaded device 121 is welded to the respective chain link 131. Thus, the respective connecting device 102a and 102b has no rotational degree of freedom relative to the coupling device.

The threaded device is configured here as a rod-shaped threaded rod, wherein one end section is welded to the chain link 131. The respective outer chain links have an essentially circular shape.

At least one inner chain link also has an elongated shape, such as the elliptical shape. Thus, sufficient space for relative movement can be provided in the cavity 132.

The outer chain links may also be integrally formed with the connecting device. Thus, an eyebolt may be provided as a combination of the chain link and the connecting device.

A further difference to the first embodiment is that the connecting devices 102a and 102b are not configured identically.

For example, the connecting device 102a has a threaded device 121a with a right-hand thread, while the connecting device 102b has a threaded device 121b with a left-hand thread. The component attachment sections are configured accordingly.

This allows the connecting means 101 to be tensioned and/or attached to the respective component in a synchronous manner. In particular, tensioning and/or attachment to both components can take place by rotating the coupling device 103. For example, an actuating device can rotate the inner chain link 131 about the axial direction, wherein after a short slip due to the approximately 90° offset about the axial direction of the chain links 131, the rotation is transmitted to the outer chain links 131. This rotation is transmitted to the threaded device 121 by the torsionally rigid coupling, whereby both connecting devices can be screwed synchronously, whereas according to the first embodiment they can be screwed independently of each other.

FIG. 4 shows a top view of a connecting means 201 according to a third embodiment.

The structure of the connecting means 201 essentially corresponds to that of the connecting means 1.

However, only a central chain link 231 is provided, to the opposite end sections of which the connecting devices 202a and 202b are coupled in the extension direction.

The coupling at the opposite coupling sections 233 corresponds to that of the first embodiment.

In this example, an actuating device can also act on the chain link 231 in order to move the components coupled to one another in space.

Furthermore, this coupling device 203 can also reliably transmit compressive forces.

Finally, FIGS. 5 and 6 show a fourth embodiment of the invention.

FIG. 5 shows a connecting means 301 in an isometric view in a closed state of the inner chain link 331. FIG. 6 shows the connecting means 301 with the inner chain link 331 in an open state.

In contrast to the first embodiment, the inner chain link 331 is configured as a carabiner link that is reversibly accessible. In particular, the inner chain link 331 can be opened and closed. For this purpose, it has a recess 334, which can be seen in FIG. 6, on a side parallel to the extension direction. A closing element 335 is provided on the chain link 331 in order to reversibly close the recess 334.

On both sides of the recess 334, threaded sections 336 are provided on the chain link 331, which are configured in an equal manner. The locking element 335 is provided with a corresponding internal thread and can bridge the two threaded sections 336 by screwing in order to close the recess 334.

In this way, further chain links can be coupled into the inner chain link 331. Thus, the connecting means 301 can be provided for various applications and spacings of components.

However, one of the outer chain links can also be configured in this way. The locking element can also be provided rotationally on a section of the chain link adjacent to the recess and transferred to the closed state by preloading. Furthermore, a locking element does not necessarily have to be provided. Preferably, however, the reversibly accessible chain link has a recess.

Further variations are now described.

The number of chain links is not limited to three and may be one or another plurality.

The coupling device may also comprise a rope or a wire or a universal joint.

In the embodiments, the connecting device comprises, and is preferably formed by, the threaded device. However, the connecting device is not limited thereto.

The connecting device can, for example, comprise a plate that extends at an end section of a shaft section, preferably at right angles to it. This plate can be welded to a component. Fastening means other than threads for the connecting devices are also conceivable. For example, a bayonet element can serve as fastening means and form the connecting device or at least be part of it.

The connecting device is preferably a device that moves as a unit, wherein further preferably no elements with a relative degree of freedom are connected between the connecting device and the component.

Although not shown, the coupling device may comprise a force measuring device capable of measuring a force, preferably at least a tensile force, acting on the coupling device.

This allows the tensile force acting on the connecting means to be easily determined. It also allows the tensioning of the components to be set precisely. In particular, the force measuring device can have a display section on which the acting force can be read.

Furthermore, the connecting device can have a shoulder section for actuating the connecting device. This shoulder section is preferably provided on a side of the coupling section that is close to the component. For example, it can include the hexagon nut. Preferably, it has a shape that differs from a round shape. It can be projecting and/or depressed. Tools can engage with the shoulder section in order to attach the connecting device to the respective component. In the above first embodiment, the hexagon nut 25 forms the shoulder section and thus also the lock section close to the component. However, the shoulder section can also be provided separately and independently of the lock section.

It is also possible to provide markings on the connecting device, preferably at even distances along the axial direction. In this way, a relative positioning between the component and the connecting device can be checked.

The state specified above, wherein component attachment sections match in alignment and position along the axial direction, is only one state that the connecting means can assume and was chosen for explanation. The components can be positioned in any order. For example, the components, in particular the component attachment sections, can be arranged along a direction transverse to the axial direction of the respective connecting device. The axes of the connecting devices can be inclined to each other.

A further aspect of the present invention is directed to a connecting assembly comprising: at least two components, preferably precast concrete components; and a connecting means as described above. One connecting device is attached to one of the at least two components, preferably screwed thereto, and the other connecting device is attached to the other of the at least two components, preferably screwed thereto.

In this way, the components can be coupled to each other by the connecting means for the transmission of loads. In particular, the components can be preloaded.

Preferably, the at least two components are freely movably supported on on another, except for the connecting means.

The connecting means thus serves as a securing means. The connecting means can thus prevent the components from being separated from each other without being connected. One application is a crane runway mounted on brackets. Thermal influences can cause the runway to contract and slide off the brackets. The connecting means is in a slack state at the time of support, wherein the chain links do not transmit any tensile forces and interlock without pretension. Ideally, the connecting means is dimensioned so as to ensure that a relative movement length from the dimensioning state to the separation between the components is greater than the maximum stretch length, which indicates the difference in length between the coupling device with chain links running on block and the coupling device with stretched chain links without preload. This means that the connecting means can serve as a securing means before slipping off the bracket.

In a connecting assembly, elements of which, in particular elements other than the components themselves, are shown in FIG. 7A, a reinforcing device 500 according to the invention is provided.

The reinforcing device 500 is coupled to one of the components by means of the connecting means 1, in particular via the connecting device 2a, and is attached thereto. The reinforcing device 500 has a base portion 501 and a reinforcing section 502.

The base portion 501 comprises an attachment section 503 with an opening section 504. The opening section 504 is formed as an elongated hole, as can be seen in particular in FIG. 7B. It should be noted that FIG. 7B has the attachment section on the other side than in FIG. 7A for reasons of illustration.

The base portion 501 has a substantially rectangular shape with rounded corners. Viewed in an extension direction of the base portion 501, the base portion preferably has an offset in an axial direction as shown here. The axial direction is a direction along the connecting device 2a, which is screwed into the one component. Thus, the base portion has a stepped shape, which simplifies assembly.

The attachment section 503 is located at one end section of the base portion 501, and the reinforcing section coupling section 505, at which the reinforcing section 502 is coupled to the base portion, is located at the opposite end section. Thus, the attachment section is offset along the axial direction from the reinforcing section coupling section. Further, the attachment section 501 is also spaced from the reinforcing section coupling section 505 in a direction perpendicular to the axial direction, that is, in the extension direction of the base portion. In this case, the direction perpendicular to the axial direction is preferably a direction perpendicular to the plane of the reinforcing section 502, which substantially defines a plane.

The reinforcing section 502 has three rod elements 502a, 502b and 502c, which are each coupled and connected to one another at their ends. The rod elements are straight extension sections of the reinforcing section 502. The coupling is preferably rigid, but can also be articulated.

As shown here, the reinforcing section is preferably formed substantially in a plane.

The three rod elements 502a, 502b and 502c form a closed shape, in particular a triangular shape. In a central portion of the rod element 502c, which is coupled to the rod element 502a at right angles, the reinforcing section is coupled to the base portion 501.

The rod element 502c is aligned parallel to the gravitational direction in an assembled state. Furthermore, the rod element 502a extends away from the side of the base portion 501 in an axial direction at an upper end section, in particular an upper end, in the gravitational direction of the rod element 502c. At an end section, in particular at an end on a side facing away from the base portion 501, the rod element 502b is coupled to the rod element 502a. The rod element 502b extends diagonally downwards in the gravitational direction and towards the side of the base portion in the axial direction. The rod element 502b couples to the rod element 502c at a lower end section, in particular at a lower end, to close the shape.

The reinforcing section 502 is coupled to the base portion 501 via a screw connection, as shown in FIG. 7B. Preferably, the reinforcing section coupling section 505 may have at least one elongated hole, in particular two intersecting elongated holes. The rod element 502c may have a threaded hole into which the screw can be screwed, or a through-hole, for example at least one elongated hole, through which a screw can be inserted in line with the elongated hole of the reinforcing section coupling section 505, wherein a nut for fastening can be provided on an opposite side of the screw head. In FIG. 7B, a washer is further interposed between the nut and the base portion.

The other connecting device 2b of the connecting means 1 is screwed into another component not shown.

The reinforcing device 500 and in particular the reinforcing section are preferably made of high-strength material, such as high-strength metal, for example steel, or composite materials such as carbon fiber reinforced composites. The reinforcing device 500 is located in an axial space 600 between the components not shown.

This space 600 can be filled by mortar, concrete or any other structure bonding agent for connecting the two components, so that the reinforcing section is at least partially, preferably completely, surrounded by the structure bonding agent. Thus, a load between the components can be at least indirectly introduced into the reinforcing device via the structure bonding agent and transmitted via the reinforcing device.

The reinforcing section 500 comprises the base portion 501, which can be attached to one of the components by means of the connecting device 2a of the connecting means 1 with an attachment section 503, and a reinforcing section 502, which is coupled to the base portion 501 and via which a load can be transmitted between the components.

By means of such a reinforcing device 500, the force transmission between the two components can be improved. In particular, a stable connection can be created via the reinforcing device 500. The reinforcing device 500 can furthermore be attached to the one component in a simple manner via the connecting means 1.

The attachment section 503 has the opening section 504, through which the one connecting device 2a can pass.

Thus, the reinforcing device 500 can be attached to the one component in a simple and space-saving manner and coupled to it by the connecting device 2a extending at least in sections through the opening section 504. In this context, the reinforcing device, or more precisely, the base portion 501 can be pressed against the one component. The opening section 504 can, for example, comprise or be a through-hole. In particular, the opening section 504 may comprise or be at least one elongated hole, preferably at least two intersecting oblong holes.

The reinforcing section 502 is adjustably coupled to the base portion 501 via the at least one elongated hole of the reinforcing section coupling section 505.

Thus, the reinforcing section 502 can be set on site according to the geometries and arrangement of the components in at least one of position and orientation. For this purpose, the reinforcing device has the elongated hole as an adjustment means. This is particularly preferred if the axes of the connecting devices 2a and 2b are offset, as in FIG. 7A. This is because it is then possible to react to this deviation by displacement along the elongated hole. The adjustability is given in particular in at least one direction perpendicular to the axial direction of the connecting device 2a.

For example, the connecting assembly may have a wall as one component and a balcony slab as the other component. The balcony slab projects from the wall in an axial direction. The balcony slab may initially be arranged with respect to the wall, preferably with an axial space, and supported via external devices.

Then, the connecting device 2a can be screwed into the wall, wherein the base portion 501 is arranged therebetween, and the connecting device 2b into the balcony slab. The two components are tensioned by screwing. The connecting means 1 is subjected to tension and the components to compression. The space can then be filled with mortar and/or concrete. After setting, the external devices can be removed.

The weight load of the concrete plate and external loads acting on it are then transmitted to the wall via the filled space in which the connecting means 1 and the reinforcing device 500 are arranged.

The rod element 502a is arranged parallel to the axial direction and is essentially subjected to tensile load by the weight of the balcony slab. The rod element 502b, on the other hand, is essentially subjected to compression. Preferably, as here, the rod element 502a is arranged, at least in sections, above the rod elements 502b and 502c.

Due to the non-parallel arrangement of the straight extension elements, a compressive load section can be formed by the rod element 502b and a tensile load section can be formed by the rod element 502a, in particular when a load is applied perpendicular to the axial direction on a side facing away from the base portion 501 in the axial direction. In particular, the straight extension section 502a is arranged substantially parallel to the axial direction and the straight extension section 502c is arranged substantially parallel to the gravitational direction.

Further, the straight extension section 502b extends in the direction of the gravitational direction and to the side of the base portion 501 at an end section of the straight extension section arranged parallel to the axial direction and facing away from the base portion.

Thus, the reinforcing device 500 can meet various loads and provide a homogeneous load.

The rod elements 502a, b and c can transmit a force in their extension direction.

This allows a well-defined force transmission to be achieved.

The reinforcing section 502 is essentially triangular in shape, in particular in the form of a right-angled, in particular preferably isosceles, triangle, wherein the rod elements 502a and c can be of equal length.

In this way, a force transmission similar to a framework can be achieved. The triangular shape can be formed by three straight extension sections connected to each other.

Although not shown, in the connecting assembly the space may have at least one undercut in the axial direction with at least one of the components.

Furthermore, in the reinforcing device 500, one of the straight extension sections, in this case the rod element 502b, can be aligned at an angle, preferably between 30° and 60°, in particular of 45°, to the axial direction.

This simplifies the load transmission.

Even if the connecting devices in FIG. 7A are offset from each other in a direction perpendicular to the respective axial direction, the axial directions coincide with each other and run parallel to the axial spacing of the components. However, the respective axial directions can also be aligned differently in the connecting assembly. Then, the axial direction refers in particular to the spacing direction of the components. In this case, the reinforcing section 502 may also be rotatably adjustable, for example about an axis perpendicular to the axial direction of the connecting device 2a.

It is also possible to provide only one straight extension element in the reinforcing section, for example the rod element 502a arranged parallel to the axial direction or the diagonal rod element 502b.

In the present case, the base portion is coupled by means of a form fit and a force fit by means of the screw connection via the opening section 504. However, the base portion 501 does not have to be attached to the one component via the opening section. The coupling can take place in at least one type of force fit, form fit and material connection. For example, if the connecting device comprises a weld plate, the base portion can also be welded to the component. The connecting means is also not necessary for attachment. For example, a simple screw can be provided. The attachment section can also be provided on both sides of the reinforcing section so that the reinforcing section is arranged symmetrically in relation to the two attachment sections.

The coupling of the reinforcing section 502 to the base portion may also be achieved by at least one type of force fit, form fit and material connection.

The components are not limited to concrete components such as precast concrete components. Rather, components made of other materials or different materials such as wood and metal can also be connected by the connecting means according to the invention.

Furthermore, a method of arranging at least two components is provided, wherein the at least two components are connected by the connecting means according to at least one of the preceding aspects, wherein the components are moved, preferably relative to one another, by an actuation at the coupling device, and preferably, after the arranging has taken place, at least one of the connecting devices is adjusted with respect to the respective component, in particular by screwing it to the respective component.

By means of the connecting means according to the invention, the components can be moved in space by actuating the coupling device, that is, by applying a load to the coupling device. If the coupling device is flexibly configured, the components can also be moved relative to each other. If, for example, the components are moved towards each other, they can be tensioned again by the connecting device once they have been arranged, that is, in the final arranging state. An actuating device for moving the components can be operated hydraulically, pneumatically or electrically, for example.

Furthermore, in this method the actuation is carried out at least in sections inside the coupling device, in particular in at least one cavity of the chain links.

Each of the method-relevant features listed above specifies this method in more detail.

The above features can be combined with each other as desired.

Unless otherwise taught by this disclosure, the term “at least” also includes the respective entirety.

1.-14. (canceled)

15. A connection apparatus for connecting at least two components spaced apart along an axial direction of the connection apparatus, the connection apparatus comprising:
at least two connecting devices, via which the connection apparatus can be attached to one of the at least two components, respectively; and
a coupling device which couples the at least two connecting devices to one another at least for transmission of tensile forces;
at least one of the connecting devices being coupled to a coupling section of the coupling device so as to be fixed at least with respect to the axial direction;
wherein the at least one connecting device is formed by a threaded device which is screwable to a respective one of the at least two components; and
the coupling device comprises at least three chain links, wherein a first one of the at least three chain links comprises the coupling section, and the at least three chain links are connected directly in series.

16. The connection apparatus according to claim 15, wherein the at least two connecting devices are each coupled to the coupling section of the coupling device so as to be fixed at least with respect to the axial direction.

17. The connection apparatus according to claim 15, wherein the at least one connecting device is movably coupled to the coupling section at least for attachment to the respective one of the at least two components, preferably coupled to the respective coupling section in particular by at least 90°, again preferably freely rotatable about the axial direction.

18. The connection apparatus according to claim 15, wherein:
the at least two connecting devices have a threaded device of a same type of pitch; or
at least a first one of the at least two connecting devices has a threaded device with a right-hand thread and at least a second one of the at least two connecting devices has a threaded device with a left-hand thread.

19. The connection apparatus according to claim 15, wherein the coupling section has an opening section which extends along the axial direction and through which at least a part of the respective one of the at least two connecting devices passes.

20. The connection apparatus according to claim 19, further including:
a first lock section on a first side facing away from the respective one of the at least two components with respect to the opening section, which at least prevents displacement of the at least one connecting device towards the respective one of the at least two components; and/or
a second lock section on a second side facing the respective one of the at least two components with respect to the opening section, which at least prevents displacement of the at least one connecting device away from the respective one of the at least two components.

21. The connection apparatus according to claim 15, wherein:
the coupling device is configured such that the at least two connecting devices are movable relative to one another; and/or
positions of the at least two connecting devices are movable relative to one another; and/or
alignments of the at least two connecting devices are changeable relative to one another.

22. The connection apparatus according to claim 15, wherein the at least three chain links comprise at least one reversibly accessible chain link into which at least a further chain link can be coupled.

23. The connection apparatus according to claim 15, wherein:
the connection apparatus can be tensioned by screwing the respective one of the at least two connecting devices to the respective one of the at least two components; and/or
by screwing the respective one of the at least two connecting devices, the at least two connecting devices can be spaced apart; and/or
the connection apparatus can be tensioned by spacing the at least two connecting devices apart.

24. The connection apparatus according to claim 15, wherein the coupling device comprises a force measuring device which can measure a force acting on the coupling device.

25. The connection apparatus according to claim 15, wherein the connection apparatus is made at least in sections of metal.

26. A connecting assembly comprising:
at least two components; and
the connection apparatus according to claim 15;
wherein a first one of the at least two connecting devices is screwed to a first one of the at least two components, and a second one of the at least two connecting devices is attached to a second one of the at least two components.

27. A method of arranging components, wherein at least two components are connected by the connection apparatus according to claim 15, the method comprising:
moving the at least two components by an actuation on the coupling device.

28. The connection apparatus according to claim 17, wherein the at least one connecting device is movably coupled to the coupling section at least for attachment to the at least two components by at least 90°.

29. The connection apparatus according to claim 17, wherein the at least one connecting device is movably coupled to the coupling section at least for attachment to the at least two components to be freely rotatable about the axial direction.

30. The connection apparatus according to claim 20, wherein the first lock section and/or the second lock section is formed by a shoulder section for actuating the respective one of the at least two connecting devices.

31. The connecting assembly according to claim 26, wherein the at least two components are freely movably supported on one another.
